(19) United States
(12) Patent Application Publication
(10) Pub. No.: US 2026/0021871 A1
(43) Pub. Date: Jan. 22, 2026

(54) LAUNCH AND RECOVERY SYSTEM AND METHOD

(71) Applicant: SAIPEM S.P.A., Milano (IT)

(72) Inventors: Alberto Fassetta, Milano (IT); Diego Lazzarin, Milano (IT)

(21) Appl. No.: 18/995,055

(22) PCT Filed: Jul. 12, 2023
(86) PCT No.: PCT/IB2023/057134

§ 371 Date: Jan. 15, 2025

(30) Foreign Application Priority Data
Jul. 20, 2022 (IT) 102022000015255

(51) Int. Cl. B63B 23/06

(52) U.S. Cl. CPC B63B 23/06

(57) ABSTRACT

A launch and recovery system has a first transportable assembly including a first base portion, a first upright arm coupled to the first base portion, and a first handling mechanism configured to move the first upright arm. The launch and recovery system has a second transportable assembly including a second base portion selectively couplable/uncouplable from the first base portion, a second upright arm coupled to the second base portion, and a second handling mechanism configured to move the second upright arm. The launch and recovery system has a third transportable assembly including a crossbeam mounted on the first and second upright arms, and a connecting device mounted on the crossbeam to selectively hold/release an underwater vehicle during launching and recovery.

### PRIORITY CLAIM

This application is a national stage application of PCT/IB2023/057134, filed on Jul. 12, 2023, which claims the benefit of and priority to Italian Patent Application No. 102022000015255, filed on Jul. 20, 2022, the entire contents of which are each incorporated by reference herein.

### TECHNICAL FIELD

The present disclosure relates to a launch and recovery system and method for launching and recovering an underwater vehicle from/on a floating vehicle.

### BACKGROUND

As is known, Launch and Recovery Systems (“LARS”) are installed on floating vehicles to enable the launch and recovery of remotely operated unmanned underwater vehicles, otherwise known as remotely operated vehicles.

In general, in order to perform launch and recovery operations it is necessary to relatively gently maneuver the underwater vehicle from a position within a floating vehicle deck to the launch and recovery area; lowering/recovering the underwater vehicle via an umbilical cable from above the water surface to an operating depth generally less than 3,000 meters; supporting the weight of the umbilical cable (which can be considerable at relatively great depths); and transmitting power and control signals to the underwater vehicle via the umbilical cable.

Typically, some floating vehicles are designed with a hollow portion inside the hull, which is commonly referred to as a moon pool and defines a launch and recovery area in calm waters. These floating vehicles are generally provided with a first type of launch and recovery system, which is integrated in the floating vehicle at the hollow portion in order to launch and recover the underwater vehicle in/from the inner launch and recovery area. In this manner, operations of the launch and recovery system are not affected by potential adverse conditions in the body of water. However, this first type of launch and recovery system requires the floating vehicle to be provided with the hollow portion, which occupies a relative considerable portion of the floating vehicle, thus limiting the range of possible operations that can be performed from the floating vehicle.

As an alternative to this type of launch and recovery system, another type of launch and recovery system can be installed, if necessary, on a deck of the floating vehicle, at a perimeter edge of the floating vehicle, in order to transfer the underwater vehicle from the deck of the floating vehicle into the water.

Generally, the structure of the type of launch and recovery system comprises a base frame attached to the deck of the floating vehicle; two upright arms hinged to the base frame around respective rotation axes; a kinematic mechanism provided by an actuator assembly configured to control a rotation of the upright arms around their respective rotation axes; a crossbeam mounted on the upright arms so as to form a gantry structure with the upright arms; and a connecting device, which is mounted on the crossbeam to selectively hold/release the underwater vehicle during the launching and recovery steps. In particular, the gantry structure allows the underwater vehicle to be contained and moved from the deck of the floating vehicle to an outboard cantilevered position, in a relatively stable and balanced manner, which safeguards the underwater vehicle from collisions with the perimeter edge of the floating vehicle as well as safeguards the integrity of the umbilical cable.

To ensure the necessary robustness of the launch and recovery system, the structure of this type of launch and recovery system is typically relatively bulky and comprises a large number of components. Consequently, the transportation and assembly of this type of launch and recovery system on the floating vehicle are relatively complex and require a relative enormous amount of time for deployment.

### SUMMARY

The present disclosure provides a launch and recovery system that mitigates certain of the drawbacks of certain of the prior art. In particular, the present disclosure provides a launch and recovery system that is relatively easy to transport by air and relatively quick to assemble and that, simultaneously, enables launch and recovery operations to be performed in a relatively efficient manner.

In accordance with certain embodiments of the present disclosure, a launch and recovery system for launching/recovering an underwater vehicle from/on a floating vehicle is provided. The launch and recovery system includes a first transportable assembly comprising a first base portion configured to rest on a deck of the floating vehicle; a first upright arm, which extends along a first longitudinal axis and is coupled to the first base portion; and a first handling mechanism configured to move the first upright arm with respect to the first base portion; a second transportable assembly substantially specular to the first transportable assembly and comprising a second base portion configured to rest on the deck of the floating vehicle; a second upright arm, which extends along a second longitudinal axis and is coupled to the second base portion; and a second handling mechanism configured to move the second upright arm with respect to the second base portion; and a third transportable assembly comprising a crossbeam configured to be mounted on the first and on the second upright arm so as to form a gantry structure with the first and the second upright arm; and a connecting device, which is configured to be mounted on the crossbeam and to selectively hold/release the underwater vehicle during the launching and recovery steps in which the first and the second base portions are couplable together on the deck of the floating vehicle so as to form a base frame for the launch and recovery system and are uncouplable from each other so as to separate the first transportable assembly from the second transportable assembly.

It should be appreciated that in accordance with certain embodiments of the present disclosure, it is possible to transport and assemble, on the floating vehicle, a launch and recovery system provided with a gantry structure in a relatively quick and easy manner. In particular, since the base frame is divided into two base portions, it is possible to transport the first base portion, the first upright arm and the first handling mechanism pre-assembled in a first container and to transport the second base portion, the second upright arm and the second handling mechanism pre-assembled in a second container. In this manner, it is possible to increase the speed and relative simplicity of the operations for assembling the launch and recovery system on board the floating vehicle. At the same time, the gantry structure of the launch and recovery system ensures the efficiency of the launch and recovery operations. In particular, the gantry structure makes it possible to support relatively heavy underwater vehicles cantilevered outboard from the floating vehicle.

In certain embodiments, the crossbeam and the connecting device are transported in a third container to further simplify the transportation of the launch and recovery system. In the context of the present disclosure, “container” means a relatively large standard, generally metal container that has the shape of a parallelepiped as well as internationally standardized dimensions for transporting objects, which can be loaded directly onto ships, railway wagons, trucks, large transport aircraft or helicopters. For example, the container has a length of approximately 6.058 meters or of approximately 12.192 meters.

In certain embodiments, each base portion comprises a plurality of longitudinal beams extending in a direction substantially parallel to a base axis, and a plurality of transverse beams extending in a direction transverse to the base axis; one end of each transverse beam of the first base portion being couplable and uncouplable with one end of a respective transverse beam of the second base portion. As such, it is possible to selectively couple/uncouple the first base portion and the second base portion relatively quickly and easily. Once the launch and recovery operations have been completed on a first floating vehicle, it is possible to dismantle the launch and recovery system and place the components in their respective containers to transport the launch and recovery system onto a second floating vehicle.

In particular, each handling mechanism is configured to move the respective upright arm between a transport position (in which the upright arm is lowered onto the respective base portion), and a launch and recovery position (in which the upright arm is fully extended cantilevered from the respective base portion). In such embodiments, once the two arms are connected by the crossbeam, it is possible to simultaneously lift the upright arms from the transport position and transfer the underwater vehicle from the deck of the floating vehicle to a launch and recovery position located outboard from the floating vehicle.

More specifically, each handling mechanism comprises a respective rotating body, which is hinged to the respective base portion around a first rotation axis and is coupled to the respective upright arm; and at least one first actuator, which is configured to implement a rotation of the rotating body around the first rotation axis so as to raise the upright arm from the transport position to an operating position, in which the launch and recovery system can support the underwater vehicle.

It should be appreciated that in accordance with each handling mechanism, it is possible to raise each arm from the transport position to the operating position, in which the underwater vehicle can be coupled to the connecting device and the launch and recovery system can perform the handling operations necessary for the launch and the recovery of the underwater vehicle. In other words, each mechanism enables each upright arm to be brought from the transport position to the operating position relatively quickly and automatically.

In certain embodiments, each upright arm is hinged to the rotating body around a second rotation axis at a distance from the first rotation axis; each handling mechanism comprising a second actuator, which is configured to implement a rotation of the respective upright arm around the second rotation axis between the operating position and the launch and recovery position. In these embodiments, it is possible to uncouple the rotation of each upright arm around the first rotation axis between the transport position and the operating position from the rotation of each upright arm around the second rotation axis between the operating position and the launch and recovery position.

In certain embodiments, each base portion comprises a first blocking element; each rotating body comprising a second blocking element configured to couple with the first blocking element so as to lock the position of the rotating body with respect to the respective base portion when the rotating body is positioned so as to place the respective upright arm in the operating position. In these embodiments, it is possible to lock the rotation of each upright arm around the first rotation axis.

In certain embodiments, each upright arm comprises a respective telescopic mechanism configured to selectively extend/retract the crossbeam along the respective longitudinal axis when the crossbeam is mounted on the upright arms. In these embodiments, it is possible to control the position of the underwater vehicle with an additional degree of freedom when the underwater vehicle is coupled to the connecting device.

In certain embodiments, the present disclosure provides a launch and recovery system that mitigates certain of the drawbacks of certain of the prior art. In accordance with certain embodiments of the present disclosure, a launch and recovery method for launching/recovering an underwater vehicle from/on a floating vehicle by a launch and recovery system is provided. The method includes transporting on the floating vehicle a first transportable assembly comprising a first base portion, a first upright arm and a first handling mechanism; transporting on the floating vehicle a second transportable assembly comprising a second base portion, a second upright arm and a second handling mechanism; transporting on the floating vehicle a third transportable assembly comprising a crossbeam and a connecting device, which is configured to be mounted on the crossbeam and to selectively hold/release the underwater vehicle during the launching and recovery steps; coupling the first base portion and the second base portion on a deck of the floating vehicle to form a base frame for the launch and recovery system; mounting the crossbeam on the first and on the second upright arm to form a gantry structure with the first and the second upright arm; and mounting the connecting device on the crossbeam.

It should be appreciated that in accordance with the method of these embodiments, it is possible to increase the speed and relative simplicity of the operations for transporting and assembling the launch and recovery system on board the floating vehicle. In practice, it is possible to transport the first pre-assembled transportable assembly in a first container and the second pre-assembled transportable assembly in a second container, which limits the components of the launch and recovery system that need to be assembled on board the floating vehicle.

### BRIEF DESCRIPTION OF THE DRAWINGS

Further features and advantages of the present disclosure will become apparent from the following description of a non-limiting example embodiment thereof, with reference to the figures of the attached drawings, wherein:

FIG. 1 is a perspective view, with parts removed for clarity, of a launch and recovery system provided in accordance with the present disclosure;

FIG. 2 is a perspective view, with parts removed for clarity, of a detail of the launch and recovery system of FIG. 1;

FIGS. 3-5 are perspective views, with parts removed for clarity and parts outlined, of respective components of the launch and recovery system of FIG. 1 in a transport configuration;

FIGS. 6-9 are perspective views, with parts removed for clarity, of the launch and recovery system of FIG. 1 in respective assembly configurations; and

FIGS. 10 and 11 are lateral elevation views, with parts removed for clarity and parts outlined, of the launch and recovery system of FIG. 1 in respective operating configurations.

### DETAILED DESCRIPTION

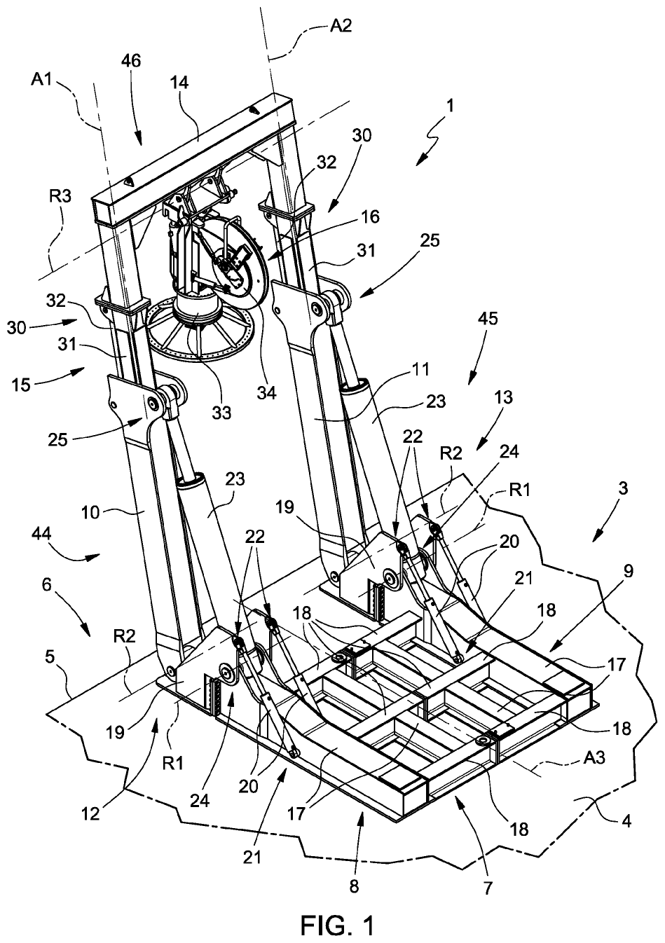

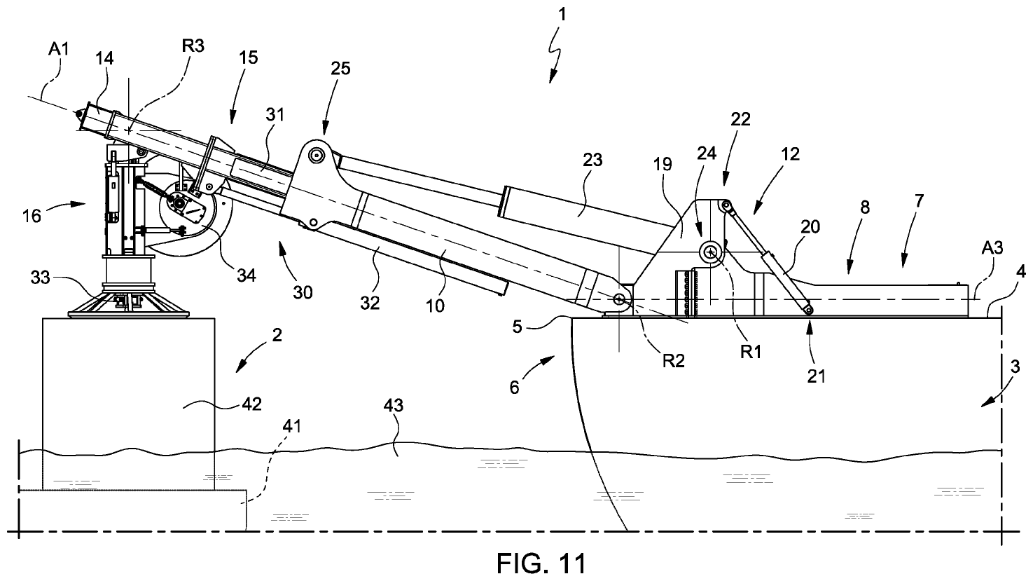

With reference to FIG. 1, the reference number 1 indicates, as a whole, a launch and recovery system for launching/recovering an underwater vehicle 2 (shown schematically in FIGS. 10 and 11) from/on a floating vehicle 3.

In particular, the launch and recovery system 1 is configured to be positioned on a deck 4 of the floating vehicle 3, at a perimeter edge 5 of the floating vehicle 3, so as to transfer the underwater vehicle 2 from the deck 4 of the floating vehicle 3 to an outboard launch and recovery position.

In the particular case described and illustrated (which is not intended to limit the present disclosure), the launch and recovery system 1 is positioned on a stern portion 6 of the floating vehicle 3.

The launch and recovery system 1 comprises a transportable assembly 44 comprising a base portion 8 configured to rest on a deck 4 of the floating vehicle 3; an upright arm 10, which extends along a longitudinal axis A1 and is coupled to the base portion 8; and a handling mechanism 12 configured to move the upright arm 10 with respect to the base portion 8.

The launch and recovery system 1 further comprises a transportable assembly 45 substantially specular to the transportable assembly 44 and comprising a base portion 9 configured to rest on the deck 4 of the floating vehicle 3; an upright arm 11, which extends along a longitudinal axis A2 and is coupled to the base portion 9; and a handling mechanism 13 configured to move the upright arm 11 with respect to the base portion 9.

In addition, the launch and recovery system 1 comprises a transportable assembly 46 comprising a crossbeam 14 configured to be mounted on the upright arms 10 and 11 so as to form a gantry structure 15 with the upright arms 10 and 11; and a connecting device 16, which is configured to be mounted on the crossbeam 14 and to selectively hold/release the underwater vehicle 2 during the launching and recovery of the underwater vehicle.

In accordance with certain embodiments of the present disclosure, the base portion 8 and the base portion 9 are couplable together on the deck 4 of the floating vehicle 3 so as to form a base frame 7 for the launch and recovery system 1, and are uncouplable from each other so as to separate the transportable assembly 44 from the transportable assembly 45. In particular, the base frame 7 is welded to the deck 4 of the floating vehicle 3. More specifically, each base portion 8, 9 of the base frame 7 is configured to be welded to the deck 4 and subsequently separated from the deck 4.

In the particular case described and illustrated, each base portion 8, 9 comprises a plurality of longitudinal beams 17 extending in a direction substantially parallel to a base axis A3, and a plurality of transverse beams 18 extending in a direction transverse to the base axis A3. One end of each transverse beam 18 of the base portion 8 is couplable and uncouplable with one end of a respective transverse beam 18 of the base portion 9. In particular, the transverse beams 18 of the base portions 8 and 9 are configured to be fixed together by suitable fixation, such as by screws and bolts, or by welding.

In practice, when the base portions 8 and 9 are coupled together, the longitudinal beams 17 and the transverse beams 18 define a grid-like structure of the base frame 7.

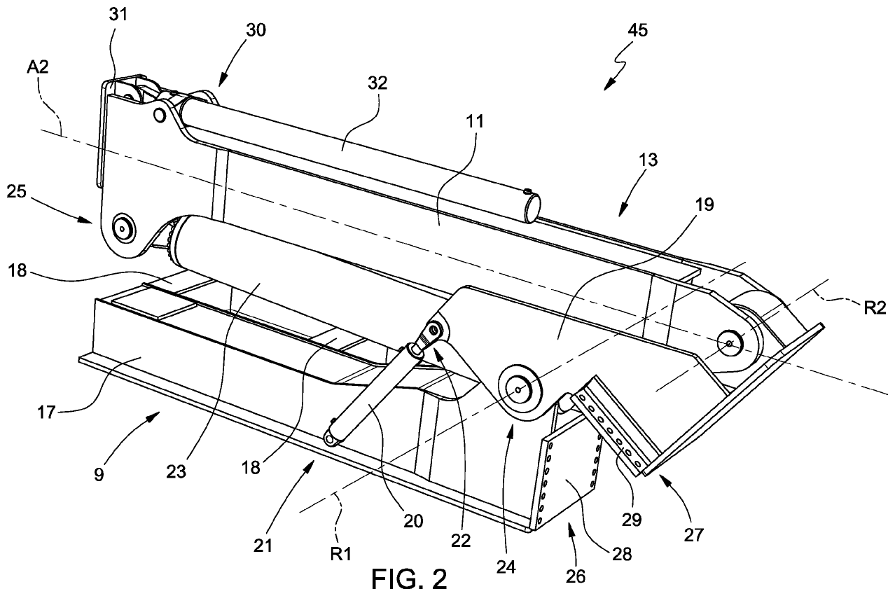

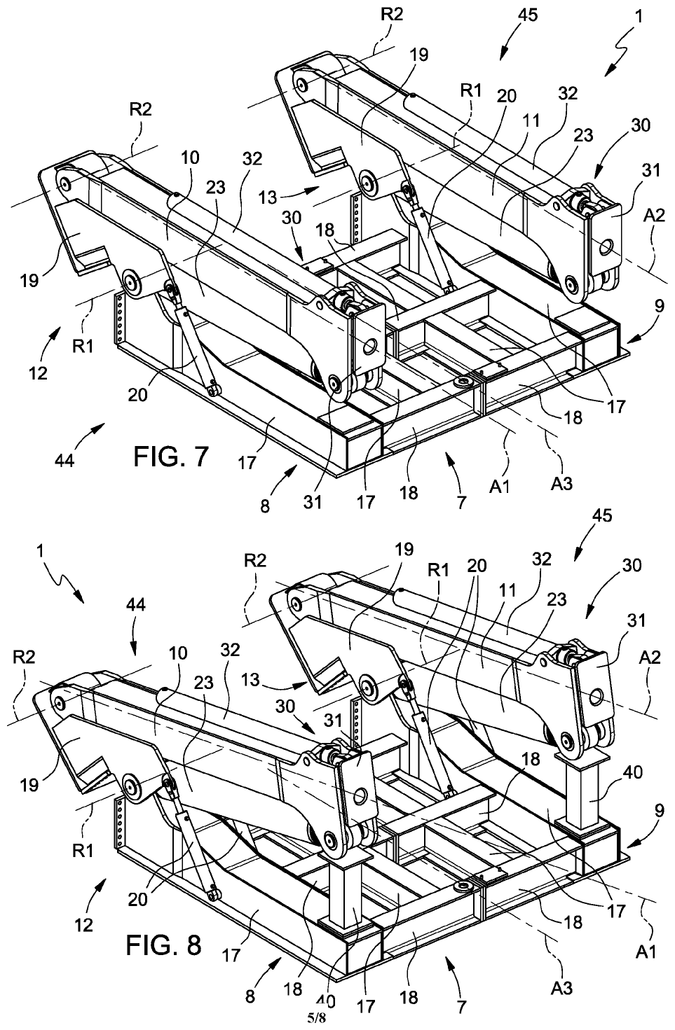

In particular, each handling mechanism 12, 13 is configured to move the respective upright arm 10, 11 between a transport position (FIGS. 2 and 7), in which each upright arm 10, 11 is lowered onto the respective base portion 8, 9, and a launch and recovery position (FIG. 11), in which each upright arm 10, 11 is fully extended cantilevered with respect to the respective base portion 8, 9.

With reference to FIGS. 1 and 2, each handling mechanism 12, 13 comprises a respective rotating body 19, which is hinged to the respective base portion 8, 9 around a rotation axis R1 and is hinged to the respective upright arm 10, 11 around a rotation axis R2 at a distance from the rotation axis R1; and at least one actuator 20, which is configured to implement a rotation of the rotating body 19 around the rotation axis R1 so as to raise the upright arm 10, 11 from the transport position (FIGS. 2 and 7) to an operating position (FIGS. 1 and 10), in which the launch and recovery system 1 can support the underwater vehicle 2. In particular, each actuator 20 comprises a hydraulic cylinder, which is hinged to the respective base portion 8, 9 by an end 21 and to the respective rotating body 19 by an end 22. More specifically, each handling mechanism 12, 13 comprises two actuators 20.

In addition, each handling mechanism 12, 13 comprises an actuator 23, which is configured to implement a rotation of the respective upright arm 10, 11 around the rotation axis R2 between the operating position (FIGS. 1 and 10) and the launch and recovery position (FIG. 11). In particular, each actuator 23 comprises a hydraulic cylinder, which is hinged to the respective base portion 8, 9 by an end 24 and to the respective upright arm 10, 11 by an end 25. More specifically, the end 24 of each actuator 23 is hinged to the respective base portion 8, 9 around the rotation axis R1.

With reference to FIG. 2, each base portion 8, 9 comprises a blocking element 26 and each rotating body 19 comprises a complementary blocking element 27, which is configured to couple with the blocking element 26 so as to lock the position of the rotating body 19 with respect to the respective base portion 8, 9 when the rotating body 19 is positioned so as to place the respective upright arm 10, 11 in the operating position (FIGS. 1 and 10). In particular, the blocking element 26 comprises a respective flange 28 and the blocking element 27 comprises a flange 29. The flanges 28 and 29 are configured to be fixed together by suitable fixation, such as by screws and bolts.

With reference to FIG. 1, each upright arm 10, 11 comprises a respective telescopic mechanism 30 configured to selectively extend/retract the crossbeam 14 along the respective longitudinal axis A1, A2 when the crossbeam 14 is mounted on the upright arms 10, 11. In particular, each telescopic mechanism 30 comprises a sliding body 31, which is configured to slide along the respective longitudinal axis A1, A2 with respect to the upright arm 10, 11 and is configured to couple with a respective portion of the crossbeam 14; and an actuator 32 configured to implement the sliding of the respective sliding body 31 along the respective longitudinal axis A1, A2. More specifically, each actuator 32 is a hydraulic cylinder configured to act between the respective upright arm 10, 11 and the respective sliding body 31.

In practice, each upright arm 10, 11 comprises a sliding seat (not shown in the figures), along which the respective sliding body 31 is configured to slide. In particular, this sliding seat is obtained inside each upright arm 10, 11.

In addition, the connecting device 16 is commonly referred to as a “snubber”, is configured to rotatably couple to the crossbeam 14 around a rotation axis R3 substantially perpendicular to the longitudinal axes A1, A2, and comprises a connecting system 33 configured to connect with the underwater vehicle 2 and a cable management system 34 configured to control the unwinding of a cable for powering the underwater vehicle 2 and exchanging data with the underwater vehicle 2. In particular, the cable management system 34 comprises a winch 34 configured to selectively wind/unwind said cable.

In practice, the connecting device 16 is coupled to the crossbeam 14 so as to enable the free rotation of the connecting device 16 around the rotation axis R3. This way, when the underwater vehicle 2 is connected to the connecting system 33, during the rotation of the upright arms 10 and 11 around the rotation axis R2, the underwater vehicle 2 translates without substantially rotating.

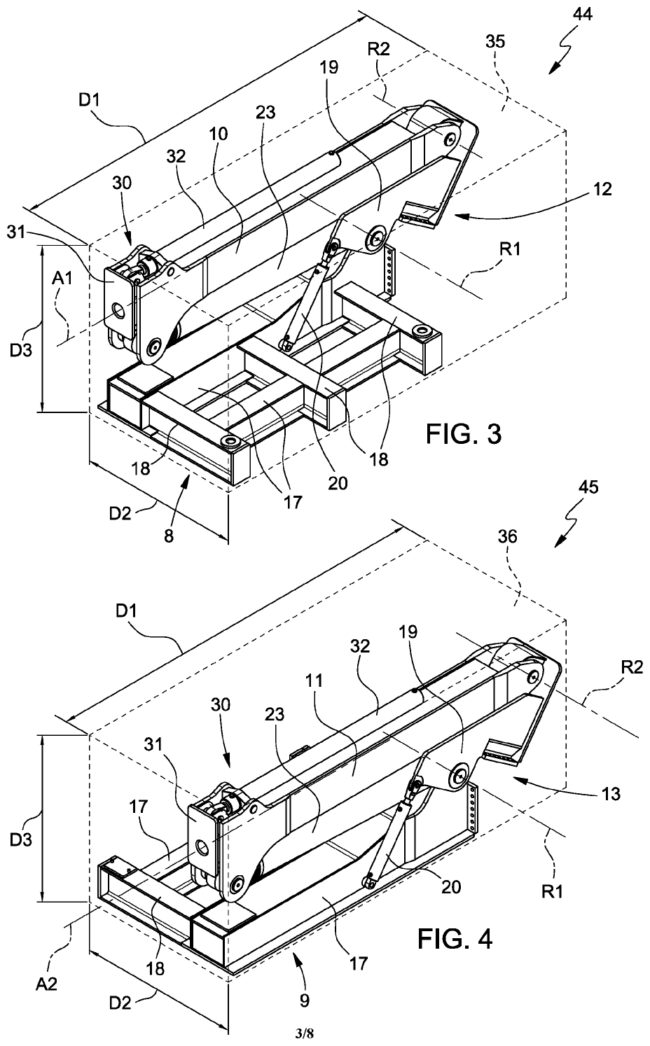

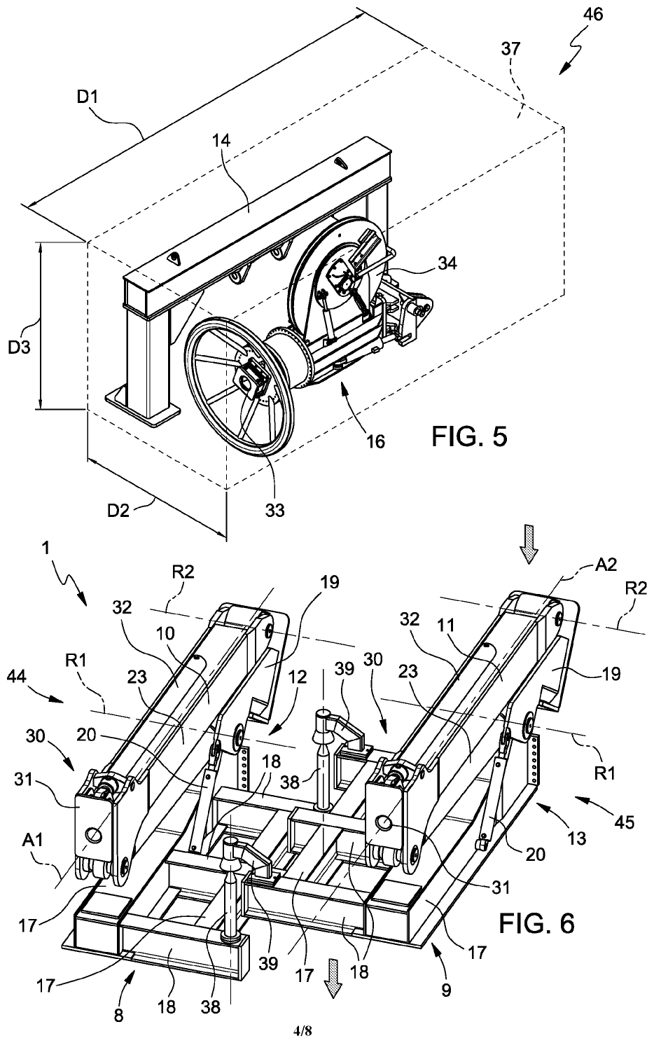

With reference to FIG. 3, the transportable assembly 44 is configured to be transported inside a container 35. In particular, the base portion 8, the upright arm 10 and the handling mechanism 12 are configured to be arranged inside the container 35 pre-assembled and in a transport position, in which the upright arm 10 is lowered onto the respective base portion 8. With reference to FIG. 4, the transportable assembly 45 is configured to be transported in a container 36. In particular, the base portion 9, the upright arm 11 and the handling mechanism 13 are configured to be arranged inside the container 36 pre-assembled and in a transport position, in which the upright arm 11 is lowered onto the respective base portion 9. With reference to FIG. 5, the transportable assembly 46 is configured to be transported in a container 37. In other words, the crossbeam 14 and the connecting device 16 are configured to be transported in the container 37.

In accordance with a non-limiting embodiment of the present disclosure, each container 35, 36, 37 has a dimension D1 of a length between 5.7 meters and 6.3 meters, a dimension D2 of a length between 2.1 meters and 2.7 meters, and a dimension D3 of a length between 2.2 meters and 2.8 meters.

In use and with reference to FIG. 3, the transportable unit 44 is transported on the floating vehicle 3 in the container 35 and, with reference to FIG. 4, the transportable unit 45 is transported on the floating vehicle 3 in the container 36. In addition, with reference to FIG. 5, the transportable assembly 46 is transported on the floating vehicle 3 in the container 37.

In accordance with a non-limiting embodiment of the present disclosure, the containers 35, 36 and 37 are transported on the floating vehicle 3 by air, in particular by helicopter. It remains understood that, in accordance with the present disclosure, the containers 35, 36 and 37 can also be transported by sea, for example by a transport vessel, or by land, for example by land vehicles or cranes, when the floating vehicle 3 is docked to land.

With reference to FIG. 6, the base portion 8, the upright arm 10 and the handling mechanism 12 are removed from the container 35 and are positioned on the deck 4 of the floating vehicle 3. Next, centering pins 38 are mounted on the base portion 8, in particular on respective crossbeams 18. The base portion 9, the upright arm 11 and the handling mechanism 13 are removed from the container 36 and centering guides 39 are mounted on the base portion 9, in particular on respective crossbeams 18. At this point, the base portion 9 is lowered towards the deck 4 of the floating vehicle 3 and each centering pin 38 is inserted into the respective centering guide 39 so that each centering pin 38 slides along the respective centering guide 39 to position the base portion 9 in a given or designated position with respect to the base portion 8.

With reference to FIG. 7, when the base portion 9 is positioned on the deck 4 in the given or designated position, the base portions 8 and 9 are coupled together to form the base frame 7. In particular, the ends of the transverse beams 18 are fixed together by suitable fixation, such as by screws and bolts, or by welding. At this point, the base frame 7 is welded to the deck 4 of the floating vehicle 3.

With reference to FIG. 8, each actuator 20 implements a rotation of the rotating body 19 about the rotation axis R1 so as to raise the respective upright arm 10, 11 from each base portion 8, 9. Once the upright arms 10, 11 have been raised from their respective base portions 8 and 9, a levelling support 40 is mounted between each base portion 8, 9 and the respective upright arm 10, 11 to support the free end of the respective upright arm 10, 11 at the same level.

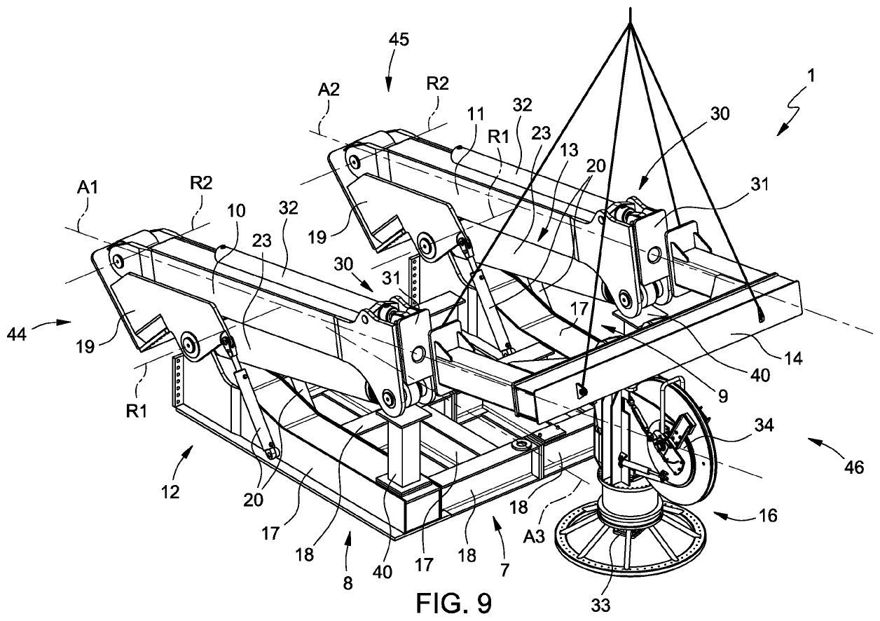

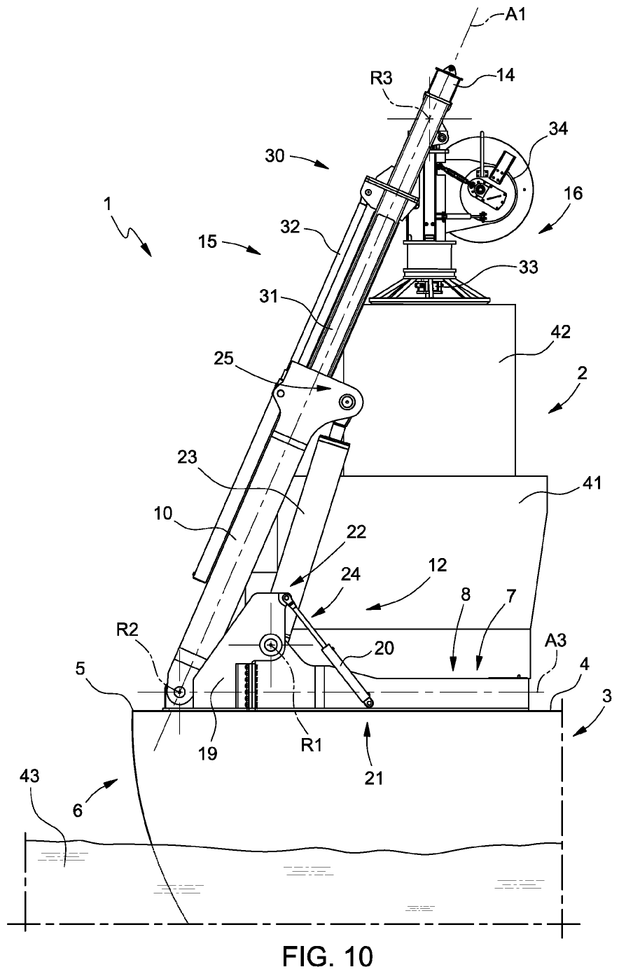

With reference to FIG. 9, the connecting device 16 is mounted on the crossbeam 14. In particular, the connecting device 16 is hinged to the crossbeam 14 around the rotation axis R3 so as to enable the free rotation of the connecting device 16 with respect to the crossbeam 14. Next, after each upright arm 10, 11 has been arranged so as to rest on the levelling support 40, the crossbeam 14 is mounted on the upright arms 10, 11 so as to form a gantry structure 15 with the upright arms 10 and 11. In particular, the crossbeam 14 is fixed to each sliding body 31.

With reference to FIG. 10, each actuator 20 is actuated so as to implement the rotation of the respective rotating body 19 around the rotation axis RI so as to raise the upright arms 10 and 11 from the transport position to the operating position. Once the upright arms 10 and 11 are arranged in the operating position, the flanges 28 and 29 of the blocking elements 26 and 27 are fixed together so as to lock the position of the rotating body 19 with respect to the respective base portion 8, 9.

Before beginning the launch and recovery operations of the underwater vehicle 2, each actuator 32 is actuated to extend/retract the crossbeam 14 along the longitudinal axes A1 and A2 in order to adjust the position of the connecting device 16. It is thus possible to adapt the distance of the connecting device 16 from the deck 4 to the dimensions of the underwater vehicle 2.

Next, the underwater vehicle 2 is connected to the connecting device 16. In the particular case described and illustrated (which is not intended to limit the present disclosure), the underwater vehicle 2 comprises a remotely operated vehicle (“ROV”) 41. In addition, the underwater vehicle 2 comprises a cable management system 42 connected to the ROV 41 and to the connecting device 16. In particular, the underwater vehicle 2 comprises a first reinforced umbilical cable (not shown in the figures), which connects the cable management system 42 to the floating vehicle 3 for power and data transmission, and a second cable (not shown in the figures), which is commonly referred to as a “tether” and connects the cable management system 42 to the ROV 41 for power and data transmission.

In accordance with an alternative embodiment (not shown in the figures), the underwater vehicle 2 comprises an autonomous underwater vehicle (“AUV”).

With reference to FIG. 11, each actuator 23 is actuated so as to implement the rotation of the upright arms 10 and 11 around the rotation axis R2 and move the upright arms 10 and 11 from the operating position to the launch and recovery position, in which the upright arms 10 and 11 are extended cantilevered from the deck 4 of the floating vehicle 3. During the rotation of the upright arms 10 and 11 about the rotation axis R2, each actuator 32 implements the sliding of the respective sliding body 31 along the respective longitudinal axis A1, A2 so as to control the position of the underwater vehicle 2.

Once placed in the water, the underwater vehicle 2 is released from the connecting device 16 so as to launch the underwater vehicle 2 into the body of water 43. At the same time, the cable management system 34 controls the unwinding of the cable for the power supply of the underwater vehicle 2 and the exchange of data with underwater vehicle 2.

Finally, it is clear that the present disclosure can be varied with respect to the described embodiment without departing from the scope of the following claims. That is, the present disclosure also covers embodiments that are not described in the detailed description above as well as equivalent embodiments that are part of the scope of protection set forth in the claims. Accordingly, various changes and modifications to the presently disclosed embodiments will be apparent to those skilled in the art.

The invention claimed is:

1-15. (canceled)

16. A launch and recovery system comprising:
a first transportable assembly comprising:
a first base portion configured to rest on a deck of a floating vehicle,
a first upright arm which extends along a first longitudinal axis and is coupled to the first base portion, and
a first handling mechanism configured to move the first upright arm with respect to the first base portion;
a second transportable assembly substantially specular to the first transportable assembly and comprising:
a second base portion configured to rest on the deck of the floating vehicle, wherein the first base portion and the second base portions are couplable together on the deck of the floating vehicle to form a base frame for the launch and recovery system, and the first base portion and the second base portions are uncouplable from each other to separate the first transportable assembly from the second transportable assembly,
a second upright arm which extends along a second longitudinal axis and is coupled to the second base portion, and
a second handling mechanism configured to move the second upright arm with respect to the second base portion; and
a third transportable assembly comprising:
a crossbeam configured to be mounted on the first upright arm and on the second upright arm to form a gantry structure with the first upright arm and the second upright arm, and
a connecting device configured to be mounted on the crossbeam and to selectively hold and release the underwater vehicle during at least one of launching an underwater vehicle from the floating vehicle and recovering the underwater vehicle on the floating vehicle.

17. The launch and recovery system of claim 16, wherein the first base portion and the second base portion are configured to be welded to the deck of the floating vehicle.

18. The launch and recovery system of claim 16, wherein each base portion comprises a plurality of longitudinal beams extending in a direction substantially parallel to a base axis, and a plurality of transverse beams extending in a direction transverse to the base axis, wherein one end of each transverse beam of the first base portion is couplable and uncouplable with one end of a respective transverse beam of the second base portion.

19. The launch and recovery system of claim 16, wherein each handling mechanism is configured to move the respective upright arm between a transport position in which the upright arm is lowered onto the respective base portion, and a launch and recovery position in which the upright arm is fully extended cantilevered from the respective base portion.

20. The launch and recovery system of claim 19, wherein each handling mechanism comprises:
a respective rotating body hinged to the respective base portion around a first rotation axis and is coupled to the respective upright arm, and
a first actuator configured to implement a rotation of the rotating body around the first rotation axis to raise the upright arm from the transport position to an operating position to support the underwater vehicle.

21. The launch and recovery system of claim 20, wherein each upright arm is hinged to the respective rotating body around a second rotation axis at a distance from the first rotation axis, each handling mechanism comprises a second actuator configured to implement a rotation of the respective upright arm around the second rotation axis between the operating position and the launch and recovery position.

22. The launch and recovery system of claim 20, wherein:
each base portion comprises a first blocking element, and
each rotating body comprising a second blocking element configured to couple with the first blocking element to lock the position of the rotating body with respect to the respective base portion when the rotating body is positioned to place the respective upright arm in the operating position.

23. The launch and recovery system of claim 16, wherein each upright arm comprises a respective telescopic mechanism configured to selectively extend and retract the crossbeam along the respective longitudinal axis when the crossbeam is mounted on the upright arms.

24. The launch and recovery system of claim 23, wherein each telescopic mechanism comprises:
a sliding body configured to slide along the respective longitudinal axis with respect to the upright arm and configured to couple with a respective portion of the crossbeam, and
an actuator configured to implement the sliding of the respective sliding body along the respective longitudinal axis.

25. The launch and recovery system of claim 16, wherein the connecting device is configured to rotatably couple to the crossbeam around a rotation axis substantially perpendicular to the longitudinal axes, the connecting device further comprising: a connecting system configured to connect with the underwater vehicle and a cable management system configured to control the unwinding of a cable for powering the underwater vehicle and exchanging data with the underwater vehicle.

26. A method of operating a launch and recovery system, the method comprising:
transporting, on a floating vehicle, a first transportable assembly comprising a first base portion, a first upright arm and a first handling mechanism;
transporting, on the floating vehicle, a second transportable assembly comprising a second base portion, a second upright arm and a second handling mechanism;
transporting, on the floating vehicle, a third transportable assembly comprising a crossbeam and a connecting device configured to be mounted on the crossbeam and to selectively hold and release an underwater vehicle;
coupling the first base portion and the second base portion on a deck of the floating vehicle to form a base frame for the launch and recovery system;
mounting the crossbeam on the first upright arm and on the second upright arm to form a gantry structure with the first upright arm and the second upright arm; and
mounting the connecting device on the crossbeam.

27. The method of claim 26, further comprising uncoupling the first base portion and the second base portion from each other to separate the first transportable assembly from the second transportable assembly.

28. The method of claim 26, further comprising transporting the first transportable assembly on the floating vehicle in a first container and transporting the second transportable assembly on the floating vehicle in a second container.

29. The method of claim 28, further comprising transporting the third transportable assembly on the floating vehicle in a third container.

30. The method of claim 26, further comprising moving the first upright arm and the second upright arm between a transport position in which each upright arm is lowered onto the respective base portion and a launch and recovery position in which each upright arm is fully extended cantilevered from the respective base portion.
